(19) United States
(12) Patent Application Publication
(10) Pub. No.: US 2008/0302600 A1
(43) Pub. Date: Dec. 11, 2008

(54) Descent control device

(76) Inventor: Richard Murray, Staten Is., NY (US)

Correspondence Address: Richard Murray, 402 Lincoln Ave., Staten Is., NY, 10306, US

(21) Appl. No.: 11/811,872

(22) Filed: Jun. 11, 2007

(51) Int. Cl. A62B 1/06

(52) U.S. Cl. 182/5

(57) ABSTRACT

This invention relates to a stationary friction-type descent control device for use with an anchored rope and a load supporting harness characterized by a block of metal having several channels spaced by furrows providing benefit of friction and a rotatably fixed mandrel having the simultaneous purpose of first slowing the advancement of rope by friction and secondly by means of said friction causing rotation of the mandrel shaft whereby a cam action impinges upon an advanced section of channeled rope providing yet additional benefit of friction; and with a detachable plate to provide simple access to the channels for sinuously installing an unloaded medial section of rope and with the plate reattached and maintained in place by means of a carabiner positioned through aligned slotted openings in the block and plate a person may descend a rope at a governed rate of speed

### BACKGROUND OF THE INVENTION

The instant invention relates generally to descent control devices such as friction or mechanical utilized with a fixed rope where the rope is wrapped around a rod or non-rotatable drum to permit descent by means of grasping the rope and delaying feed of the rope. Such devices are instrumental during firefighters self rescue from untenable elevated positions requiring constant grasp of the rope with an additional problem of rope spiral causing the introduction of pigtails and kinks in the free end prior to entry into the control device. Of concern is the weight of firefighters coupled with a heavy ensemble of protective clothing and breathing apparatus and then being required to descend several stories while attached to scant 7.5 mm diameter ropes where excessive speed of descent can cause rope breakage during abrupt stoppage of descent.

The instant invention relates more specifically to a new improved descent control device that is designed to govern speed of descent free of hand control and absence of rope rotation thereby preventing excessive speeds of descent and without interference of kinks in the free end of the rope. Governed speed of descent is accomplished by the rope's first entry into the descent control device through means of friction around a mandrel causing partial rotation of the shaft and a second action of friction where shaft rotation activates cam impingement on the rope in a channel formed into a metal block with still a third means of friction brought about by more channels with intervals of furrows inviting a serpentine course of rope travel. The descent control device having a detachable plate provides an open view of the channels whereby the device can be attached to a rope at any point between it's ends. Convenient aligned slots in the block and the plate offer the introduction of a carabiner for the purpose of maintaining the plate to the block and marrying the device to a load supported body harness. One end of the mandrel is circumferentially enlarged to prevent unintentional removal of the turn of rope upon entry into the device while the shaft of the mandrel is machined providing a notch to receive a matched opening in the plate further locking the plate to the block. The shaft is secured in position by means of a set screw which permits slight rotation of the shaft. Throughout the duration of governed speed of descent kinetic energy converts to heat and the heat is evenly distributed within the descent control device and therefore provides for a cooled passage of rope which further reduces the possibility of rope breakage.

### SUMMERY OF THE INVENTION

The principle object of the present invention is to provide a new and improved descent control device that absorbs and evenly distributes converted heat from kinetic energy and prevents excessive speeds of descent which can result in dangerously high impact loads in a fixed rope system.

Another object of the present invention is to provide a descent control device that is simple, small, lightweight and governs the descending speed of a three hundred pound load at five to eight feet per second.

A further object of the present invention is to provide a friction type descent control device that can be attached to a fixed rope anywhere between it's ends without having to access either end.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

FIG. 1 is a perspective view of the instant invention showing a rope fed through the device and carabiner linkage to a load supported harness tie-in point.

FIG. 2 is a side perspective view of the mandrel and shaft.

FIG. 3 is a front perspective view of the block with the plate removed and a clear view of the exposed channels and bottom furrow.

FIG. 4 is a front perspective view of the detachable cover plate.

### DETAILED DESCRIPTION OF THE PREFERRED EMBODIMENT

Turning now descriptively to the drawings, in which similar reference characters denote similar elements throughout the several views, the Figures illustrate a block 5 for a descent control device which consists of channels 6 and furrows 7 for the entry and passage of a rope 11. A mandrel 1 is rotatably secured into the block 5 by means of a set screw (not shown) positioned against the shaft 4 of the mandrel 1. A carabiner 10 is detachably connected to the block 5 through a slotted opening 8 after which the carabiner can in turn be connected to a load bearing harness tie-in point (not shown). Starting at the free end of the rope 12 entry of the rope begins with a single wrap around the mandrel 1 then into the channel (not detailed) and outward 13 to a anchor point.

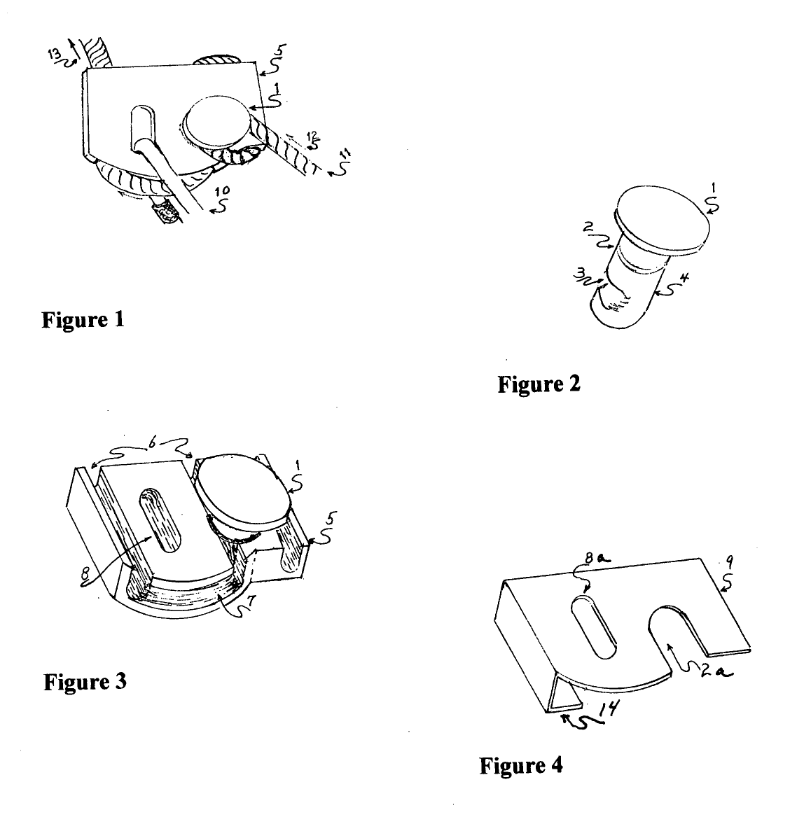

As shown in FIGS. 1 and 2 the mandrel 1 has a rotatable shaft 4 where a cam 3 created by a grooved area impinges on a rope 11 as the rope advances through the block 5. One turn of rope 11 is applied to the mandrel 1 whereby ensuing friction causes rotation of the shaft 4.

The shaft 4 shown in FIGS. 2 and 4 has a notch 2 which receives the matching slip 2a when the plate 9 is positioned onto the block 5.

What is claimed is:

1. A descent control device comprising of a metal friction block having a series of aligned channels enclosed by a detachable plate and wherein a mandrel and shaft is perpendicularly positioned between two channels.

2. The mandrel of claim 1 wherein the mandrel is rotatably attached yet it is limited to one quarter turn.

3. The mandrel of claims 1 and 2 wherein the mandrel is enlarged circumferentially at it's exposed end preventing an applied wrap of rope from unintentional removal.

4. The mandrel of claims 2 and 3 wherein the mandrel rotates due to friction born from the wrap of rope on the mandrel.

5. The mandrel in claims 1 and 2 wherein the shaft of the mandrel is of cam design and when rotated causes partial obstruction of the center channel and thereby impingement action and reduced speed of rope travel through the channels.

6. The descent control device of claim 1 that uninhibitedly governs the speed of descent from five to eight feet per second for loads of more than three hundred pounds.

7. The descent control device of claim 1 and 6 that absorbs and evenly distributes heat during descent brought about by friction and the transformation of kinetic energy to heat.
